(19) United States
(12) Patent Application Publication
(10) Pub. No.: US 2016/0062455 A1
(43) Pub. Date: Mar. 3, 2016

(54) ELECTRONIC DEVICE AND METHOD FOR ADJUSTING BRIGHTNESS OF DISPLAY SCREEN

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SAN CHIANG, New Taipei (TW); SHUANG HU, Shenzhen (CN); LING-JUAN JIANG, Shenzhen (CN); HUA-DONG CHENG, Shenzhen (CN)

(21) Appl. No.: 14/710,826

(22) Filed: May 13, 2015

(30) Foreign Application Priority Data
Sep. 3, 2014 (CN) 201410444703.3

(51) Int. Cl. G06F 3/01; G09G 5/10

(52) U.S. Cl. CPC G06F 3/013; G09G 5/10

(57) ABSTRACT

In a display screen brightness adjustment method, vision information of a user is obtained. A nearest distance, a longest distance, and an optimal distance between the user and the display screen are determined. An actual distance between the user and the display screen is detected. The actual distance is compared to the nearest distance, the longest distance, and the optimal distance. Then a brightness value of the display screen is calculated. Accordingly, brightness of the display screen is adjusted.

### CROSS-REFERENCE TO RELATED APPLICATIONS

This application claims priority to Chinese Patent Application No. 201410444703.3 filed on Sep. 3, 2014, the contents of which are incorporated by reference herein.

### FIELD

The subject matter herein generally relates to display technologies, and more specifically relates to, an electronic device and a method for adjusting brightness of a display screen.

### BACKGROUND

Display screens are equipped on electronic devices for displaying information, such as texts, pictures or videos. Currently, a brightness of display screens is commonly adjusted manually.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a display screen brightness adjustment system.

FIG. 2 is a block diagram of one embodiment of function modules of the display screen brightness adjustment system in FIG. 1.

FIG. 3 is a flowchart of one embodiment of a method for adjusting brightness of a display screen.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

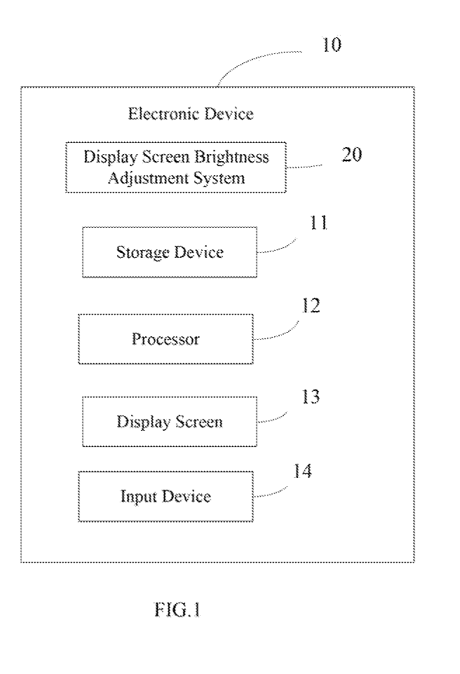

FIG. 1 is a block diagram of one embodiment of a hardware environment for executing a display screen brightness adjustment system. The display screen brightness adjustment system 20 is installed and runs in an apparatus, for example an electronic device 10. In at least the one embodiment as shown in FIG. 1, the electronic device 10 includes, but is not limited to, a storage device 11, at least one processor 12, a display screen 13, and an input device 14. The electronic device 10 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

The display screen brightness adjustment system 20 can obtain vision information of a user and detect an actual distance between the user and the display screen. Accordingly, a brightness value of the display screen is calculated. Then, the system 20 can adjust brightness of the display screen according to the calculated brightness value.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the display screen brightness adjustment system 20 in the electronic device 10.

The input device 14 can be a keyboard, or a touch panel, which can generate commands in response to input operations. In the embodiment, the input device 14 can generate a command for inputting vision information of a user in response to a first input operation. The vision information includes viewing distance of left eye VL and viewing distance of right eye VR. The input device 14 can generate a command for inputting identity of a user in response to a second input operation. The identity of a user includes account and password associated with the account.

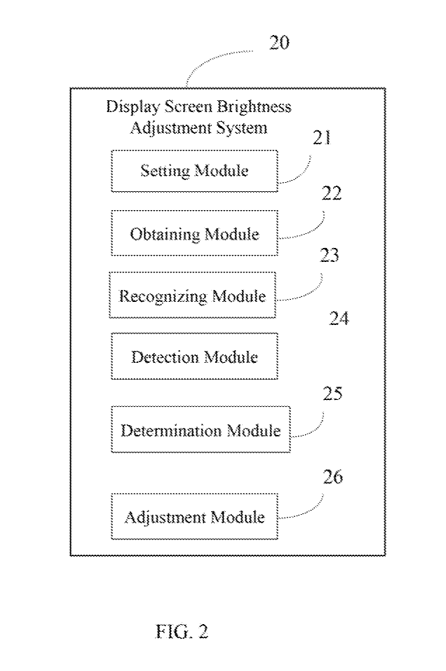

FIG. 2 is a block diagram of one embodiment of the function modules of the display screen brightness adjustment system 20 in FIG. 1. In at least one embodiment, the display screen brightness adjustment system 20 can include a setting module 21, an obtaining module 22, a recognizing module 23, a detection module 24, a determination module 25, and an adjustment module 26. The function modules 21-26 can include computerized codes in the form of one or more programs, which are stored in the storage device 11. The at least one processor 12 executes the computerized codes to provide functions of the function modules 21-26.

The setting module 21 can generate a first sheet and a second sheet in response to input operations. The first sheet records relationships between users and the vision information of the users. The second sheet records relationships between vision information of a user and brightness of the display screen PB when the display screen 13 has an optimal display effect to the user.

The determination module 25 can determine a nearest distance LO, a longest distance LN, and an optimal distance LB between the user and the display screen 13. In the embodiment, the determination module 25 determines the nearest distance LO according to a formula LO=1/[(VL+VR)/2], determines the longest distance according to a formula LN=4/[(VL+VR)/2], and determines the optimal distance LB according to a formula LB=(LO+LN)/2.

The recognizing module 23 can recognize the identity of a user who is currently using the display screen 13 of the electronic device 10. In the embodiment, a user can enter his or her account and password, and the recognizing module 23 recognizes the account and password to recognize the user. The obtaining module 22 can obtain vision information of the user from the first sheet.

The detection module 24 can detect an actual distance L between the user and the display screen 13. The determination module 25 can compare the actual distance L to the nearest distance LO, the longest distance LN, and the optimal distance LB. The adjustment module 26 can calculate a brightness value of the display screen 13 according to the comparison result determined by the determination module 25. The adjustment module 26 further can adjust the brightness of the display screen 13 according to the calculated brightness value.

When the actual distance L is longer than the longest distance LN, or nearer than the nearest distance LO, that is, L>LN or L<LO, the adjustment module 26 can shut down the display screen 13. For example, the adjustment module 26 turns off power for backlight modules of the display screen 13 to shut down the display screen 13. When the actual distance L is nearer than the longest distance LN, and longer than the nearest distance LO, that is, LO<L<LN, the adjustment module 26 calculates a brightness of display screen 13 according to a formula P=PB+[(L−LB)/Lt]*Pt. Lt and Pt are parameters predefined by user or system to adjust the brightness of the display screen 13, PB is the brightness of the display screen 13 when the display screen 13 has an optimal display effect for the user.

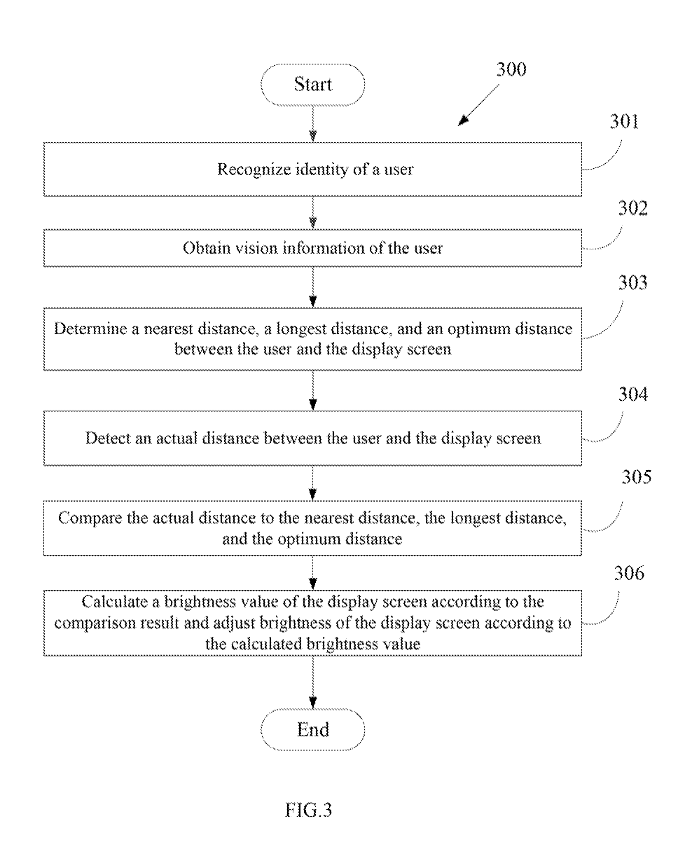

FIG. 3 is a flowchart of one embodiment of a method for adjusting brightness of a display screen.

FIG. 3 illustrates a flowchart is presented in accordance with an example embodiment. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301. Depending on the embodiment, additional steps can be added, others removed, and the ordering of the steps can be changed.

At block 301, the recognizing module recognizes an identity of a user who is currently using the display screen of the electronic device.

At block 302, the obtaining module obtains vision information of the user from the first sheet.

At block 303, the determination module determines a nearest distance LO, a longest distance LN, and an optimal distance LB between the user and the display screen.

At block 304, the detection module detects an actual distance L between the user and the display screen.

At block 305, the determination module compares the actual distance L to the nearest distance LO, the longest distance LN, and the optimal distance LB.

At block 306, the adjustment module calculates a brightness value of the display screen according to the comparison result and further adjusts brightness of the display screen according to the calculated brightness value.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for adjusting brightness of a display screen executable by at least one processor of a computing device, the method comprising:
obtaining vision information of a user;
determining a nearest distance, a longest distance, and an optimal distance between the user and the display screen;
detecting an actual distance between the user and the display screen;
comparing the actual distance to the nearest distance, the longest distance, and the optimal distance;
calculating a brightness value of the display screen according to the comparison result; and
adjusting brightness of the display screen according to the calculated brightness value.

2. The method according to claim 1, wherein the vision information of a user comprises viewing distance of left eye VL and viewing distance of right eye VR, the nearest distance is determined according to a formula LO=1/[(VL+VR)/2], the longest distance is determined according to a formula LN=4/[(VL+VR)/2], and the optimal distance is determined according to a formula LB=(LO+LN)/2.

3. The method according to claim 2, further comprising shutting down the display screen when the actual distance is longer than the longest distance.

4. The method according to claim 2, further comprising shutting down the display screen when the actual distance is nearer than the nearest distance.

5. The method according to claim 2, further comprising calculating the brightness value of display screen according to a formula P=PB+[(L−LB)/Lt] *Pt, when the actual distance is near than the longest distance, and longer than the nearest distance, Lt, Pt are parameters predefined to adjust brightness of the display screen, PB is the brightness of the display screen when the display screen has an optimal display effect to the user, and L is the actual distance.

6. The method according to claim 1, further comprising generating a relationship sheet recording visions of users and brightness of the display screen when the display screen has an optimal display effect to each of the users.

7. An electronic device, comprising:
a display screen;
at least one processor; and
a storage device that stores one or more programs which, when executed by the at least one processor, cause the at least one processor to:
obtain vision information of a user;
determine a nearest distance, a longest distance, and an optimal distance between the user and the display screen;
detect an actual distance between the user and the display screen;
compare the actual distance to the nearest distance, the longest distance, and the optimal distance;
calculate a brightness value of the display screen according to the comparison result; and
adjust brightness of the display screen according to the calculated brightness value.

8. The electronic device according to claim 7, wherein the vision information of a user comprises viewing distance of left eye VL and viewing distance of right eye VR the nearest distance is determined according to a formula LO=1/[(VL+VR)/2], the longest distance is determined according to a formula LN=4/[(VL+VR)/2], and the optimal distance is determined according to a formula LB=(LO+LN)/2.

9. The electronic device according to claim 8, wherein the display screen is shut down when the actual distance is longer than the longest distance.

10. The electronic device according to claim 8, wherein the display screen is shut down when the actual distance is nearer than the nearest distance.

11. The electronic device according to claim 8, wherein brightness of display screen is calculated according to a formula P=PB+[(L−LB)/Lt] *Pt, when the actual distance is near than the longest distance, and longer than the nearest distance, Lt, Pt are parameters predefined to adjust brightness of the display screen, PB is the brightness of the display screen when the display screen has an optimal display effect to the user, and L is the actual distance.

12. A non-transitory storage medium having stored thereon instructions that, when executed by a processor of an electronic device, causes the processor to perform a method for adjusting brightness of a display screen, wherein the method comprises:
obtaining vision information of a user;
determining a nearest distance, a longest distance, and an optimal distance between the user and the display screen;
detecting an actual distance between the user and the display screen;
comparing the actual distance to the nearest distance, the longest distance, and the optimal distance;
calculating a brightness value of the display screen according to the comparison result; and
adjusting brightness of the display screen according to the calculated brightness value.

13. The non-transitory storage medium according to claim 12, the vision information of a user comprises viewing distance of left eye VL and viewing distance of right eye VR, the nearest distance is determined according to a formula LO=1/[(VL+VR)/2], the longest distance is determined according to a formula LN=4/[(VL+VR)/2], and the optimal distance is determined according to a formula LB=(LO+LN)/2.

14. The non-transitory storage medium according to claim 13, wherein the display screen is shut down when the actual distance is longer than the longest distance.

15. The non-transitory storage medium according to claim 13, wherein the display screen is shut down when the actual distance is nearer than the nearest distance.

16. The non-transitory storage medium according to claim 13, wherein brightness of display screen is calculated according to a formula P=PB+[(L−LB)/Lt] *Pt, when the actual distance is near than the longest distance, and longer than the nearest distance, Lt, Pt are parameters predefined to adjust brightness of the display screen, PB is the brightness of the display screen when the display screen has an optimal display effect to the user, and L is the actual distance.
